(19) United States
(12) Patent Application Publication
(10) Pub. No.: US 2011/0318698 A1
(43) Pub. Date: Dec. 29, 2011

(54) ZERO WATER DISCHARGE OVEN COOLING

(76) Inventors: Siddhartha Gaur, Plano, TX (US); Vibha Bansal, Plano, TX (US)

(21) Appl. No.: 12/825,055

(22) Filed: Jun. 28, 2010

(51) Int. Cl. F27D 3/00; F27D 15/02

(52) U.S. Cl. 432/11; 432/85

(57) ABSTRACT

A tunnel oven and method for heating transported carbonaceous material includes an enclosure with a passage having a first and second length and an interconnection between the first and second length. A transport device in the passage moves solid carbonaceous material through and along the first length of the passage. A water cooling mechanism along the second length of the passage and a cooling controller operatively coupled to the cooling mechanism to provide a quantity of water for cooling the carbonaceous material to a temperature below the oxidation temperature of the carbonaceous material in air and above the boiling point of the water so that the quantity of water is completely vaporized to form steam and the carbonaceous material is discharged at the cooled temperature without any liquid water discharge.

### BACKGROUND OF INVENTION

1. Field of the Invention

The invention relates generally to an apparatus and method for heating and cooling of carbonaceous material, and in particular to an apparatus and method for continuous heating of carbonaceous material above the ignition temperature of the carbonaceous material, such as tunnel kilns, conveyor ovens, or other continuous heating ovens and for cooling of such carbonaceous material.

2. Background Art

Prior devices and methods for heating carbonaceous material to high temperatures are known. Such as for heating coal in a reduced oxygen atmosphere to produce coke. After the carbonaceous material in such prior devices and methods has been heated, they are typically removed at a high temperature and are allowed to cool. In many cases the resulting material, such as the resulting coke, is cooled at an accelerated rate such as by water quenching or by convective cooling by the flow of a gas over the heated material. In the case of water cooling, the water also serves to capture any loose dust particles and the liquid water with entrained particulate matter is typically disposed into settling ponds or reservoirs, and in some cases directly into rivers, streams. In such settling ponds and reservoirs the heaviest particulate carbonaceous matter in the water settles to the bottom and the water is recovered. Unlined ponds can allow a portion of the carbonaceous material and other solids to seep into the ground and potentially to mix with ground water. In some instances the water collected from settling ponds or otherwise discharge water might be further purified or treated; however, such purification generally requires expensive means to satisfactorily filter or otherwise fully clean the discharged cooling water. Recently, in the case of coke production from coal, others have attempted to avoid or reduce the liquid water discharge situation in the cooling of the coke from a high temperature by using large volumes of inert gas to cool the coke. Such a process is expensive, requiring circulation of very large volumes of inert gas to cool the coke within an acceptably short time period.

### SUMMARY OF INVENTION

In one or more embodiments of the invention, a tunnel oven for heating transported carbonaceous material includes an enclosure with a passage having a first and second length and an interconnection between the first and second length. A transport device in the passage moves solid carbonaceous material through and along the first length of the passage. A heater is operably connected to the enclosure to heat the carbonaceous material as the carbonaceous material is moved along the first length of the passage thereby releasing high temperature exhaust gases in the first length of passage. An atmosphere controller controls the atmosphere along the first length of the passage, the atmosphere controller includes a temperature controller operably coupled to the heater to provide one or more selected temperatures along the first length of the passage. A vent is positioned proximate to the interconnection of the first and second lengths of the passage. A water cooling mechanism along the second length of the passage and cooling controller for operatively coupled to the cooling mechanism to provide a quantity of water for cooling the carbonaceous material to a temperature below the oxidation temperature of the carbonaceous material in air and above the boiling point of the water so that the quantity of water is completely vaporized to form steam. A pressure controller in the first and second passage controls a pressure distribution between the first length of passage and the second length of passage so that the pressures in both first and second lengths of the passage are higher than a pressure in the vent, wherein the exhaust gases and the steam are vented from the passage through the vent without any liquid water discharged from the tunnel oven.

In one or more embodiments volatile components of the carbonaceous material are released with products of combustion in high temperature exhaust gases upon heating along the first length of the passage. The vented steam from the second length of the passage is mixed with the high temperature exhaust gases from the heating in the first length of the passage and the mixture is evacuated from the oven passage. The temperature of the steam created upon cooling the carbonaceous material will be generally less than the temperature of the exhaust gases. The resulting temperature of the gaseous mixture of combined high temperature exhaust gases and steam is less than the temperature of the exhaust gasses and greater than the temperature of the steam. Heat energy of the exhaust gases and also heat energy of the water vapor, including the latent heat of vaporization, can be usefully recovered using equipment that is designed to operate at moderately high temperatures less than the temperature of the exhaust gases alone. Such moderate temperature equipment is typically less expensive and more durable than equipment that might otherwise be required to handle the higher temperature of the exhaust gases alone. For example, the recovered energy can be used in preheating the oven, in other plant operations, in a cogeneration system within the plant, or in electrical generation for returning the energy to an energy grid for use by others. Thus, cost effectively, energy recovery devices or cogeneration devices such as turbines and heat exchangers that operates at the lower combined temperature of the exhaust and steam mixture may be used.

In one or more embodiments, entrained carbon particulate materials can be cleaned from the mixture and can be recovered for reuse or disposal. Removal of entrained particulates from the exhaust and steam mixture can be usefully accomplished with equipment designed for operation at temperatures lower than the exhaust gases. Cost effective low temperature cleaning equipment such as particulate separators and filtering devices can be used.

Other aspects and advantages of the invention will be apparent from the following description and the appended claims.

### BRIEF DESCRIPTION OF DRAWINGS

FIG. 1 is a schematic cutaway side view of a tunnel oven with water cooler according to one embodiment of the invention.

FIG. 2 is a schematic section view of the tunnel oven FIG. 1, taken along section line 2-2.

FIG. 3 is a graph of temperature versus time or length of travel at a constant rate in a tunnel oven.

FIG. 4 is a graph of a volatile gas removal versus temperature of a carbonaceous material heated from a low temperature to progressively higher temperatures in a tunnel oven.

### DETAILED DESCRIPTION

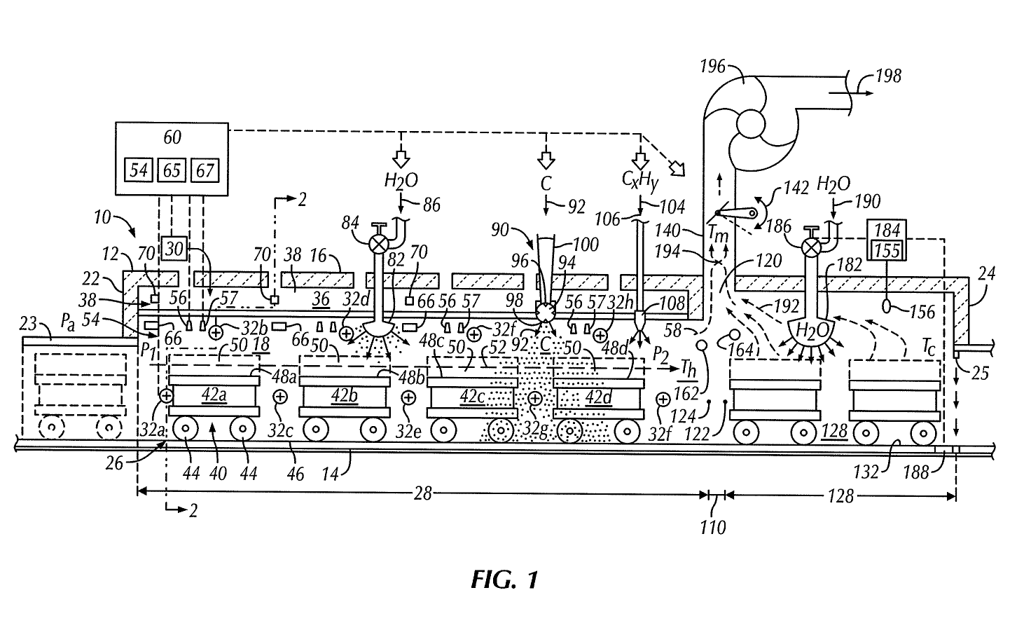

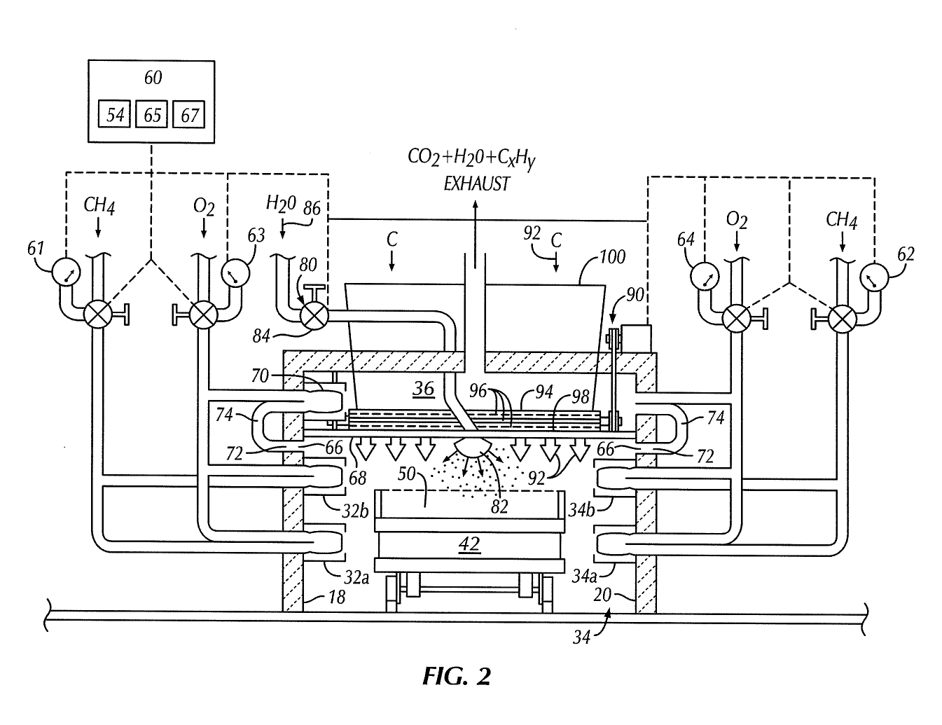

FIG. 1 shows a schematic cutaway side view of a tunnel oven 10 according to one embodiment of the invention. FIG. 2 shows a cutaway end view of the tunnel oven 10 shown in FIG. 1. An enclosure 12 has a bottom 14, a top 16, sidewalls 18 and 20 (side wall 20 not shown in FIG. 1, see FIG. 2), entrance end 22 and exit end 24. A passage 26 extends through the enclosure 12 of the tunnel oven 10 having a first length 28, that comprises a heating section for heating the carbonaceous material 50 and a second length 128, that may comprise a continued length or a cooling chamber interconnected with the first length 28, for cooling the heated carbonaceous material 50 after it has been heated in the first length 28. A heater system 30 is provided to heat the passage 26 along the first length 28. The heater system 30 may include a plurality of burners 32, for example burners 32a-j, along one side wall 18. It will be understood that the number of burners 32a-j can vary depending upon the size of the tunnel oven 10 and the size and heating capabilities of the burners so that high temperatures are obtained in the heated material within a commercially acceptable length of time. In one embodiment, another set of a plurality of burners 34 may be provided along the opposing sidewall 20. The second set of burners may be beneficially positioned along the opposing sidewall 20 in alternating spatial on relationship relative to the burners 32 on the sidewall 18 to provide good heat distribution. (For clarity, only burners 34a-b are shown in FIG. 2). The heater system 30 may also include a combustion chamber 36 constructed along the roof 38 between the top 16 and the tunnel oven passage 26. The heater system 30 operates on a positive pressure basis such that a fuel, air, and exhaust gas mixture inside the passage 26 has a pressure P1 that is greater than the outside atmospheric pressure Pa so that it acts to exclude the introduction of air from outside the oven. Thus, introduction of air into the passage 26 is reduced to an acceptably low amount while still permitting carbonaceous material 50 to be introduced into the oven through an entrance end 22. The carbonaceous material 50 is moved through the first length 28 of tunnel oven passage 26 where it is heated, it is moved at 110, for example through a transition length at 110, into the second length 128 of passage 26 where it is cooled, and it is moved out of the oven passage 26 from an exit end 24. The entrance 22 may be opened for insertion of the carbonaceous material and then closed for continuous, controlled atmosphere heating. The exit end 24 may be opened for removal of a batch or a portion of carbonaceous material 50 that has been heated and cooled and then closed for controlled atmosphere heating and cooling of a next batch or portion of the carbonaceous material after it has been heated in the heating section 28. For example, heat and atmosphere separating devices 23 and 25 may be provided on the entrance end 22 and the exit end 24, respectively. The entrance and exit separating devices 23 and 25 are designed to temporarily move out of the path of the carbonaceous material to allow entry and exit to-and-from the tunnel oven passage 26 and to close or otherwise form a barrier to exchange of atmosphere while the carbonaceous material 50 is within the tunnel oven 10.

Those skilled in the art will understand from this disclosure that one example of separating devices 23 and 25 are known as vestibules (as shown at 23 in FIG. 1). A first or entrance vestibule 23 at the entry to the oven passage may comprise a chamber that has a front door and a back door. The front door is closable to the ambient atmosphere and the back door is positioned adjacent to the tunnel oven entry end 22 and is effectively sealed around to the passage 26 of the tunnel oven 10. In operation the back door is closed, and the front door is opened to receive the carbonaceous material 50 while the back door remains closed. When the carbonaceous material 50 is within the vestibule, the front door is also closed and then the back door is opened to allow the carbonaceous material 50 to move through the back door and then into entrance end 22 and the tunnel oven passage 26. The reverse procedure may be employed to let the carbonaceous material 50 exit from the exit end 24 of the tunnel oven passage 26. A second separating device 25 may be an exit vestibule 25 adjacent exit end 24 of the oven. In the case of an exit vestibule it may comprise a first door that is openable to allow the heated carbonaceous material 50 to exit the tunnel oven passage 26 and go into the second vestibule while a second door is closed. When the carbonaceous material 50 is within the second vestibule, the first door is closed and the second door is opened to let the carbonaceous material 50 exit without loosing more than a very small portion of the atmosphere maintained in the tunnel oven so that control of the atmosphere is maintained.

Those skilled in the art will also understand from this disclosure that as an alternative example, the separating devices 23 and 25 might be one or more moving air curtains (as shown at 25). Moving air curtains provide a plurality of aligned high velocity air jets that move air past the exit end 24, or if used at both ends, also past the entrance end 22. The solid carbonaceous material 50 can pass through the air curtain; however, the rapidly moving air creates a boundary layer barrier to the transfer of gaseous atmosphere. When the carbonaceous material 50 is in the tunnel oven 10, the air curtain acts to separate the exterior, ambient atmosphere from the interior, controlled atmosphere in the tunnel oven 10.

A transport device 40 may be used to carry and transport the carbonaceous material 50 through the tunnel oven 10 according to one embodiment of the invention. One example of a transport device 40 includes a plurality of material carrying carts 42a-d having temperature resistant metal wheels 44 guided along temperature resistant tracks 46. The number of carts 42a-d depicted is an example of one embodiment. It will be understood that the number of carts 42 may depend upon the size of the carts and the intended capacity of the tunnel oven 10 such that the letter designations a-d are representative and are not intended to limit the number. The carts 42a-d may each movably support one or more of a plurality of container 48a-d for carrying carbonaceous material 50. The containers 48a-d may be made of a high temperature heat resistant and relatively inert material such as refractory material so that the containers 48a-d do not combust, oxidize, or otherwise chemically react or interfere with the combustion of the fuel gases and the heating of the carbonaceous material 50. It will be understood by those skilled in the art based upon this disclosure that other high temperature transport devices 40 might be constructed for transporting carbonaceous material 50 along the passage 26 through the enclosure 12 of tunnel oven 10. For example, and without limitation, a conveyor belt system with the requisite thermal and chemical resistance or a plurality of temperature resistant and chemically inert rollers might be used without departing from certain aspects of the invention.

In the embodiment depicted in FIG. 1 and FIG. 2 the burners 32a-j may be methane gas burners positioned above and below the path indicated by arrow 52, of the carbonaceous material 50 to be heated as the carbonaceous material 50 is moved through the tunnel oven passage 26. On the opposite sidewall 20 methane burners 34a-j may be provided to facilitate uniform controlled heating (for clarity only burners 34a-b are shown in FIG. 2) and atmosphere controller referred to generally with reference number 60. It will be understood that atmosphere control with atmosphere controller 60 refers to control of one or more characteristics of the atmosphere within the tunnel oven 10. For example, according to one or more alternative embodiments, atmosphere controller 60 may control the temperature, the pressure, the chemical content of the atmosphere, or any combination of such characteristics of the atmosphere 59 that is in contact with carbonaceous material 50 within the tunnel oven 10. It will also be understood that of the total number of burners 32 and 34 depicted in the figures or listed by series designations 32a-j or 34a-j, is by way of example only. There may be any number of burners depending upon the size of the burners, the heating capabilities of the burners, and the size, length and heating requirements for the tunnel oven.

In one or more embodiments, the atmosphere controller 60 comprises a temperature controller 54 to adjustably obtain a desired temperature along the passage 26 of the tunnel oven 10. The temperature controller 54 may beneficially maintain the desired temperature. In one or more embodiments, the temperature controller 54 may be used to obtain and maintain a plurality of different desired temperatures along the passage 26 of the tunnel oven 10. The temperature controller 54 may include one or more thermostats 55 connected to one or more temperature sensors 56 that are positioned along the tunnel oven passage 26. A plurality of sensors 56 may be positioned spaced apart at a plurality of positions along the first length 28 of the tunnel oven passage 26. In one or more embodiments, each of the plurality of sensors 56 may be positioned in an area where the temperature is affected by a particular one or more burners 32 and/or 34 burners and each may be coupled to one of a plurality of thermostats 55 so that the sensors and thermostats work to usefully provided separately controlled temperatures at the various positions in the passage. Thus the temperature controller 54 may control any number of the positions to have the same temperature or several different temperatures. The thermostats 55 may be physically located at or near the location of the sensors 56 (typically external to the passage 26 of the tunnel oven 10) or may be remotely located at a remote control station such as a remote computer control station that may comprise hardware and/or software control system communicatively coupled to the sensors 56.

In one or more embodiments, the atmosphere controller 60 comprises an atmosphere chemical content controller 67 that may include one or more chemical content sensors 57 provided at one or more locations along the tunnel oven passage 26 to monitor the chemical content of the atmosphere 59 within the tunnel oven passage 26. In one embodiment, the atmosphere sensors 57 may comprise oxygen sensors. Oxygen content is one chemical of significant concern in the process of heating carbonaceous material according to the invention. The oxygen content of the atmosphere 59 that surrounds the heated carbonaceous material 50 within the tunnel oven 10 during heating of the carbonaceous material 50 will affect the amount of oxidation of the carbonaceous material 50 when it is heated. The presence of too much oxygen can cause combustion and small quantities of oxygen in the heating atmosphere 59 can cause oxidation on the surface of the carbonaceous material 50 or may otherwise interfere with non-oxidizing heating of carbonaceous material 50. It is useful for some purposes to provide completely non-oxidizing heating to the carbonaceous material 50, for example, in the formation of coke from coal. In one or more embodiments, the atmosphere controller 60 may comprise temperature sensors 56 that may be used in the atmosphere controller in coordination with the chemical sensors 57 to monitor a plurality of characteristics of atmosphere 59 and to facilitate controlling the atmosphere 59 so that the carbonaceous material 50 may be heated to above the combustion temperature of the carbonaceous material 50 without oxidation of the carbonaceous material 50. Both the chemical content controller 67 and the temperature controller 54 may coordinate control of heater mechanism 30, such as burners 32a-j and 34a-j, and based upon input from the oxygen sensors 57, the temperature sensors 56 and the thermostats 55, the fuel and oxidant to the burners 32a-j and 34a-j may be adjusted using temperature settings of the thermostats 55 and according to a desired low oxygen content. According to one or more embodiments the temperature sensed by temperature sensors 56 may be compared to temperature settings at the thermostats and if the sensed temperature is too low, heat produced by the burners is increased and if the temperature is too high the heat produced by the burners is decreased. If the oxygen content is too high the ratio of fuel to air is adjusted. Thus, the desired temperatures along the first length 28 of tunnel oven passage 26 may be obtained and maintained with a temperature controller component of the atmosphere controller 60. In one or more embodiments, the heater system 30 may also comprise a combustion chamber 36 formed along and adjacent to the tunnel oven passage 26, as for example, above and along a roof 38 of the tunnel oven 10. The combustion chamber 36 may be used to provide primary heat as by injection of fuel and oxidant into the combustion chamber 36, supplemented by the burners. Alternatively, the combustion chamber 36 may be used to provide supplementary heat in addition to the heat provided by the burners. For example, volatiles released from the heated carbonaceous material 50 and injected into the combustion chamber 36 with or without additional injection of fuel to efficiently capture and use the chemical energy of the volatiles. Combustion within the combustion chamber 36 may also be controlled by temperature controller 54, using the sensors and thermostats and in combination with control of the burners so the desired temperatures in and along the tunnel oven passage 26 are obtained.

In one or more embodiments, the atmosphere controller 60 further controls the pressure of the atmosphere within the tunnel oven passage 26 such as by a pressure controller 65 that may include one or more fuel pressure regulators 61 and 62 and oxidant pressure regulators 63 and 64 so that positive pressure P1 is maintained within the tunnel oven passage 26. Particularly, the pressure, or a pressure gradient, may be controlled so that a positive pressure P1 is maintained adjacent to the entrance end 22. In one embodiment, the pressure P1 of the oven atmosphere may be controlled by using one or more gas pressure regulators 61 and 62 to adjust the pressure and volume of methane gas, and by using one or more air pressure regulators 63 and 64 to adjust the pressure and volume of air (the source of oxygen, O₂).

In one or more embodiments, the atmosphere controller 60 includes a chemical controller 67 that further controls one or more chemical component of the atmosphere. In one embodiment, the atmosphere sensors 57 are oxygen sensors used to monitor the oxygen level within the tunnel oven 10 and the chemical controller 67 may use the sensed oxygen content to provide oxygen proportionately to the methane gas in the burners and to increase the oxygen when additional methane gas fuel is added to raise the temperature, or to reduce the oxygen when the methane gas fuel is reduced to lower the temperature. The proper gas pressure, air pressure and thus the combustible mixture may thus controlled by the chemical controller 67 as part of the atmosphere controller 60. The chemical controller 67 beneficially works together with the pressure controller 65 so that the desired positive pressure is maintained within the tunnel oven passage 26. A gradient of pressure is desirably provided along the length of the tunnel oven passage 26 with higher pressure P1 at the entrance end 22 and lower pressure P2 at the exit end 24, such that both P1 and P2 are higher than the external atmospheric pressure. For example, the individual burners may each have separate regulators 61, 62, 63, and 64 corresponding to each burner 32a-j and 34a-j, respectively. Each burner 32a-j and 34a-j may be adjusted to progressively decrease pressure from the entrance burners 32a and 34a to burners 32j and 34j adjacent the exit end 24. Alternatively, according to one or more embodiments, several regulators may control separate zones comprised of several burners. Thus, for example, the burners 32a and 32b may be adjusted at one setting for both pressure and volume to obtain the desired heating rate in one zone and the desired pressure P1 and a lower setting for both pressure and volume of methane gas and air injected in another zone with the burners 32i and 32j so that a pressure P2 is obtained that is greater than the atmospheric pressure and slightly lower than the positive entrance pressure P1. As will be explained more fully below, the pressure controller 65 may also comprise a vent control valve 69.

The temperature is controlled also by the amount of heat provided by combustion of the fuel with the O₂ in the air. To avoid the carbonaceous material 50 oxidizing in the air, an excess amount of methane fuel is provided within the atmosphere of the tunnel oven passage 26. Thus, direct convection heating of the carbonaceous material 50 to temperatures above the combustion temperature of the carbonaceous material 50 can be accomplished without oxidizing the surface of the carbonaceous material 50. The heat generated is therefore controlled by regulating the amount of fuel and air (hence the amount of methane and O₂) injected into the burners. The atmosphere sensors 57 are used to monitor the atmosphere quality so that the oxygen level is lean and an excess amount of fuel or combustible hydrocarbon evolved from the heated carbonaceous material 50 is present for combustion. Thus, in one embodiment, the temperature and atmosphere are controlled according to the temperature sensed at sensors 56 and the oxygen sensed by atmosphere sensors 57 along the tunnel oven passage 26 inside of the tunnel oven 10 adjacent to the burners or in the zones or areas surrounding the burners that are thus adjusted.

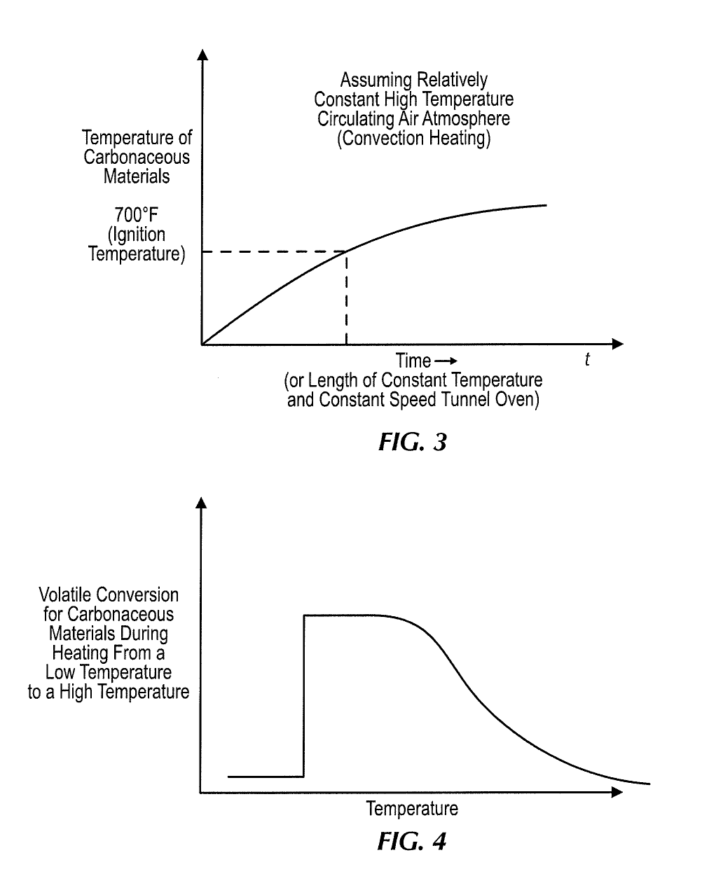

With reference to the graph of FIG. 3, it will be understood that when the carbonaceous material 50 is subjected to circulating burning gases from the burners 32 and 34, and assuming a high temperature atmosphere 59 is continuously maintained within the tunnel oven passage 26, the temperature of the carbonaceous material 50 will be raised by direct convection heat transfer from the surrounding oven atmosphere 59. The graph depicts the raise in temperature as a function of time. For carbonaceous material 50 moving along the tunnel oven passage 26 at a constant speed, the time is also related to the length of the passage that is traverse. Methane gas used in the burners 32 and 34 will burn at temperatures that are substantially above the ignition temperature of the carbonaceous material. For example, above the ignition temperature of about 700° C. Referring to FIG. 5, it will also be understood that when the carbonaceous material 50 reaches a temperature at which volatiles are given off or evolved, a significant portion will be given off rapidly over a range of increasing temperatures and then as the temperatures increase further, the amount of evolved volatiles will decrease until all the volatiles have been released. The range of temperatures and specific temperatures at which release of volatiles is initiated and completed will depend upon the composition of the carbonaceous material. Generally, a portion of the volatiles are likely to be light, highly combustible hydrocarbons and others may be larger hydrocarbon chains. In one or more embodiments, the light volatiles may be used to provide at least a portion of the burning energy in the tunnel oven passage 26 and the amount of methane fuel may be reduced accordingly. Any excess unburned volatiles and unburned methane gas may be extracted at extraction ports 66 and then re-circulated through conveyance tubes 72 into a burner 70 positioned in the combustion chamber 36.

In the event the volatiles or portions of the volatiles released from the carbonaceous material are long chain hydrocarbons prior to heating, they may be expected to break down into lighter shorter chain hydrocarbons at sufficiently high temperatures above the ignition temperature of other portions of the carbonaceous material. The long chain volatiles might not ignite while in the tunnel oven passage 26. Such chains may be further cracked in a cracking zone 74 positioned along the conveyance tubes 72 so that the hydrocarbons can be efficiently burned in the combustion chamber 36. The heat thereby generated in the roof is conveyed to the tunnel oven passage 26 and to the material transported by conduction through the ceiling 68 and by radiant energy heat transfer from the ceiling 68 into the tunnel oven passage 26 and directly to the carbonaceous material 50. Thus, the mixture of air to fuel in the roof combustion chamber 36 can be adjusted to a stoichiometric balance or to provide an excess proportion of oxygen (O₂) without the O₂ combining with the carbonaceous material 50 transported through the tunnel oven 10.

In one or more embodiments, the temperature can be further controlled by a heat reducer mechanism 80 that can be coupled as a part of the temperature controller 54 and as part of the atmosphere controller 60. Such a cooler mechanism may be positioned in the first length 28 of the tunnel oven passage 26 and may comprise a water injector such as a spray nozzle 82 adjustably supplied with water through a valve 84 in fluid communication with a water supply 86. It will be understood that the number and placement or positioning of the heat reducer mechanism 80 is not intended to be limited to a single spray nozzle 82 as depicted for a schematic example in FIGS. 1 and 2. More than one heat reducer mechanisms 80 and multiple alternative placements and positioning along the heating section 28 of tunnel oven passage 26 may also be useful as will be understood by those skilled in the art based upon the present disclosure.

In one embodiment, the atmosphere 59 in the tunnel oven 10 is further controlled to avoid oxidation of the solid carbonaceous material 50 by injecting carbon dusts 92. A carbon dust injection mechanism 90 may be used that includes a carbon dust source 84. The dust injecting mechanism is usefully designed to introduce the carbon dust into the heating length 28 of the tunnel oven passage 26 without introducing significant additional air and without allowing too much of the internal atmosphere to escape from the tunnel oven 10. In one embodiment, the carbon dust injection mechanism 90 may comprise a dust injector that may include a distributor roller 94 having a plurality of troughs 96 cut into the surface. The roller is rotated in a seal 98 such that carbon dust 92 contained in a hopper 100 is distributed from the hopper into the tunnel oven 10 as the distributor roller 94 is rotated. Thus, even when all of the excess hydrocarbon fuel is depleted by combustion in the tunnel oven passage 26 and/or in the combustion chamber 36, the dust particles have a significantly larger percentage of surface area and form the preferred oxidation sites for any remaining oxygen. The carbonaceous material 50, and in particular solid carbonaceous material 50, is therefore relatively protected against surface oxidation reaction in the area or zone where the carbon dust is injected. The carbon dust 92 may be advantageously the same material as the carbonaceous material 50 so that its presence does not adversely affect the heating processes occurring in the carbonaceous material 50. It will be understood that the number and placement or positioning of the carbon dust injection mechanism 90 is not intended to be limited by the depiction of only one in the schematic example of FIGS. 1 and 2. More than one carbon dust injection mechanism 90 and multiple alternative placements and positioning may also be useful as will be understood by those skilled in the art based upon the present disclosure. The relative positioning of the heat reducer mechanisms 80 and the carbon dust injection mechanisms 90 may also be varied according to the heating process, the temperatures and the atmospheric control desired for the relative raising and lowering of the amount of heating of carbonaceous material 50 at various locations along the heating section 28 within the tunnel oven 10.

In one or more embodiments, of the invention the atmosphere in the heating section 28 of the tunnel oven passage 26 of the tunnel oven 10 may be controlled to provide preferred reaction with injected hydrocarbon fluids such as a hydrocarbon gas 104 or a mist of at least partially vaporized of hydrocarbon oil 106, as for example, through a hydrocarbon injector 108. As with the carbon dusts 92, the combustion components in the hydrocarbon gas 104 or vaporized oil 106 will be more readily combusted than the solid carbonaceous material 50 so that the carbonaceous material 50 will be protected against oxidation.

In one or more embodiments, as may be understood with reference again to FIG. 1, cooling is accomplished in a second length 128 of the tunnel oven passage 26. The second length 128 may comprise continuation of the tunnel oven passage 26 that may for example, be considered as a cooling section or it may comprise a cooling chamber that interconnects with the tunnel oven passage 26 to receive the heated carbonaceous material 50 for cooling it after the heating process is completed. A water cooling device 182 and cooling controller 184 are operatively positioned in the second length 128 of the tunnel oven passage 26 of the tunnel oven 10 to apply a quantity of liquid cooling water 190 to the heated carbonaceous material 50. The quantity of liquid cooling water 190 applied is controlled to cool down or to quench the carbonaceous material 50 from the heated oven temperature Tₕ to a lower temperature T_{c}, in the second length 128. In one or more embodiments, the lower temperature that results from the water cooling is usefully controlled so that T_{c} is above the boiling point of water under the conditions existing in the second length 128 and so that all the quantity of applied liquid cooling water 190 is completely vaporized to form steam 192. For example, at standard sea level pressure the boiling point of pure water may be about 100° C. The temperature Tₕ of the heated carbonaceous material 50 after being heated in the first length of the tunnel oven passage 26 of tunnel oven 10 may be at about 700° C., the temperature of the exhaust gases 58 in the oven may be at or above about 1500° C. Before extracting the carbonaceous material 50 out of the controlled non-oxidizing atmosphere of the tunnel oven it may be beneficial to cooled the heated carbonaceous material 50 to below about 300° C. so that oxidation does not readily occur upon removing the carbonaceous material 50 from the controlled non-oxidizing atmosphere 59. To be sure that all the cooling water 190 is vaporized and forms steam 192, the temperature in the oven at the exit end 24 should be above the boiling point of the water, for example above 100° C. for sea level pressure and higher for higher positive pressures as may be maintained in the atmosphere 59 of the tunnel oven 10. Thus, a temperature above 100° C. and below 300° C. has been found by the inventors to be a good range with a target low cooled temperature T_{c} for the exiting carbonaceous material 50 may be about 200° C. Under thermodynamic equilibrium, all the water 190 will be converted to steam 192 at a temperature above the water boiling point, as it forms saturated steam 192 as it reaches 100° C. and then becomes super heated steam 192 as it increases above 100° C. Those skilled in the art will understand that in a dynamic system, a temperature higher than the boiling point may be required to comfortably minimize and eliminate the liquid phase completely so that there will be zero liquid water discharge. Thus, all the liquid water 190 used for cooling becomes super heated steam 192 in the second length 128 of passage 26. In one example, either or both the quantity of water and the time period that the carbonaceous material 50 resides in the second length 128 of tunnel oven passage 26, or the cooling section 128 of the tunnel oven passage 26, may be appropriately adjusted or controlled to cool a given quantity of material from a particular high temperature Tₕ to a desired lower temperature T_{c}. The cooled temperature T_{c} will usefully be sufficiently below carbon combustion temperatures to avoid oxidation upon discharge of the material into the uncontrolled ambient atmosphere outside of the oven, and sufficiently above a dynamic super heated steam condition for the process. In one or more embodiments a time period may be established by the process time involved for the heating of the carbonaceous material 50, the volume of material, the temperature Tₕ of the heated material and the physical second length 128 of the tunnel oven passage 26. The amount of cooling can be controlled by a controller 184 such that may comprise an adjustable valve 186 and a temperature sensor 156 so that the controller 184 adjust the valve 186 to obtain a desired cooled temperature T_{c} indicating that all the cooling water 190 will turn into super heated steam 192. For example, if the cooled temperature T_{c} is maintained in a range sufficiently above the boiling point of water, all the liquid water 190 will turn to steam 192. In one example, of the operation of controller 184, if the cooled temperature T_{c} is below the target cooled temperature, for example below about 200° C., then the valve 186 is activated to restrict water flow volume or to close completely. If the cooled temperature T_{c} is above the target temperature, then the valve 186 is activated to increase the water flow volume so that the temperature in the second length 128 of passage 26 is reduced. If the temperature T_{c} is the same as the target temperature, no change is made in the position of valve 186. By operation of the controller 184 a desired temperature T_{c} is maintained. It will be understood that the target temperatures may be a range of temperatures so that T_{c} is maintained in the range of target temperatures. If the lower end of an acceptable range or temperatures is reached the cooling water may be shut off by closing the valve completely and if the temperature is above the upper end of the desired range, for example, above about 300° C. the valve may be activated to open completely to increase the water flow volume so that the temperature in the cooling length of tunnel oven passage 26 is maintained in a range of above about 100° C. and below about 300° C. Thus, the appropriate volume of water is provided as required for cooling to temperatures within the super heated steam range for the particular system and so that no liquid water remains to be discharged from the system.

In one or more embodiments, the cooled temperature T_{c} in the cooling length 128 of tunnel oven passage 26 can be controlled more precisely to a specific desired temperature above the steam saturation temperature and in the super heated steam temperature range.

In one embodiment, a liquid sensor 188 may be provided positioned toward the exit end 24 of the cooling length 128 of the tunnel oven passage 26 and toward the bottom 132 of the tunnel oven passage 26. Thus, upon sensing an accumulation of water by sensor 188, a signal can be provided to controller 184 and the volume of cooling water can be adjusted and reduced using controller 184 and valve 186. In the event that there might be a concern that all the waters 190 was not vaporized, the volume of water can be decreased, the speed of movement of the carbonaceous material 50 can be slowed, or both water volume and transport speed slowed to allow sufficient time for heat to transfer from the carbonaceous material 50 to the cooling water 190 for complete vaporization to steam 192 of all the remaining liquid water 190.

In one or more embodiments, a vent 140 is in communication with the second length of passage 128 to remove the vaporized cooling water as steam 192. A pressure controller mechanism 65 maintains relative pressure in the first length 28 and second 128 length of tunnel oven passage 26 so that the steam 192 is evacuated through the vent 140 without interfering with the heating in the first length 28 of passage 26. The pressure control mechanism 65 may comprise one or more pressure sensors 162, 164 and the vent valve 142.

In one or more embodiments, the vented steam 192 from the second length 128 of tunnel oven passage 26 is mixed with the high temperature exhaust gases 58 from the first length 28 of the tunnel oven passage 26. In the embodiment depicted in FIG. 1, the mixing of steam 192 and exhaust gases 58 begins at the entrance 120 to the vent 140 to form a gaseous mixture 194 that is evacuated together through the vent 140. The entrance 120 to the vent 140 may be positioned at or adjacent to the end 124 of the first length 28 of the tunnel oven passage 26 and at or adjacent to the beginning 122 of the second length 128 of tunnel oven passage 26. When mixed together the combined temperature Tₘ of the gaseous mixture 194 of exhaust gases 58 and steam 192 becomes a moderate temperature Tₘ that is less than the temperature Tₕ of the exhaust gasses 58 and greater than the temperature T_{c} of the water vapor or the steam 192. The steam component 192 effectively becomes a higher temperature super heated steam in the mixture 194. Any dust, ash, soot and carbon particulate material that may have been entrained in either the steam 192 or the exhaust gases 58 is also carried by the mixture 194 and can be cleaned from the mixture 194 and can be recovered for reuse or for disposal. For example, in the case of carbon material the carbon might be reused in the formation of the carbonaceous material 50 to be heated, and in the case of ash or other impurities, the material can be disposed of appropriately. Usefully, carbon particles may be entrained in the vaporized cooling water and may be removed at 198 with equipment (not shown) designed for operation at temperatures lower than the exhaust gases. Thus, cost effective low temperature cleaning equipment such as, particulate separators and filtering devices can be used. Because the temperature Tₘ of the mixture is a moderate temperature, expensive high temperature processes need not be used for cleaning and filtering the particulate matter from the mixture 194.

Heat energy in the gaseous mixture 194 can also be effectively recovered using equipment such as a co-generation device 196 such as a turbine or other energy recovery apparatus, designed for operation at the combined temperature Tₘ that is significantly lower than the temperature Tₕ of the exhaust gases 58. Also usefully, heat energy from the high temperature of the exhaust gases and also heat energy from the water vapor, including the latent heat of vaporization, can be recovered. Because of the mass of the volume of gas and steam mixture is large, compared to the mass of the exhaust gas by itself, and because of the latent heat of vaporization in super heated steam in the mixture 194, the energy content is high. Thus, not only can the energy in the exhaust gases 58 be recovered, but also a significant portion of the heat energy that was in the heated carbonaceous material 50 can also be recovered. The energy from the heat in the carbonaceous material 50 is transferred to the steam 192 and, in turn, into the mixture 194. Also, the energy is stored in the mixture 194 at a temperature Tₘ that is lower than the temperature Tₕ of the exhaust gas 58. Thus, energy recovery equipment can be designed for operation at the combined temperature (lower than the exhaust gas temperature) may be recovered for use in the oven or for use in a cogeneration system. Cost effective, relatively low temperature energy recovery devices or cogeneration devices 196 such as turbines and heat exchangers can also be used. The recovered energy can, for example, be used in the oven, used in other plant operations, used in a cogeneration system, or returned to an energy grid for use by others.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A tunnel oven for heating transported carbonaceous material comprising:
an enclosure with a passage having a first and second length and an interconnection between the first and second length and an exit from the second length;
a transport device in the passage for moving solid carbonaceous material through and along the first length and the second length of the passage and to discharge the carbonaceous material out of the exit;
a heating mechanism and atmosphere controller operatively connected in the first length of passage for heating the carbonaceous material in an oxidation reduced atmosphere; and
a water cooling mechanism along the second length of the passage and a cooling controller for operating coupled to the cooling mechanism to provide a controlled quantity of water for cooling the carbonaceous material to a cooled temperature below the oxidation temperature of the carbonaceous material in air and above the boiling point of the water so that the quantity of water is completely vaporized to form steam, and wherein the carbonaceous material is discharged from the exit at the cooled temperature without any liquid water discharge.

2. The tunnel oven as in claim 1, wherein the at least one cooler comprises at least one water spray mechanism placed in at least one position along the passage adjacent to the exit to cool the carbonaceous material to a cooled temperature below the oxidation temperature of the carbonaceous material in air such that the surface of the carbonaceous material is protected from oxidation when discharged from the exit into ambient air.

3. A tunnel oven for heating transported carbonaceous material comprising:
an enclosure having a passage with a first and second length and an interconnection between the first and second length;
a transport device for moving solid carbonaceous material through and along the first length of the passage;
a heater operably connected to the enclosure to heat the carbonaceous material as the carbonaceous material is moved along the first length of the passage thereby releasing high temperature exhaust gases in the first length of passage;
an atmosphere controller to control the atmosphere along the first length of the passage, the atmosphere controller comprising a heating temperature controller operably coupled to the heater to provide one or more selected temperatures along the first length of the passage;
a vent positioned proximate to the interconnection of the first and second lengths of the passage;
a water cooling mechanism along the second length of the passage and cooling controller operatively coupled to the cooling mechanism to provide a quantity of water for cooling the carbonaceous material to a temperature below the oxidation temperature of the carbonaceous material in air and above the boiling point of the water so that the quantity of water is completely vaporized to form steam; and
a pressure controller in the first and second passage for maintaining a pressure distribution between the first length of passage and the second length of passage so that the pressures in both first and second lengths of the passage are higher than a pressure in the vent, wherein the exhaust gases and the steam are vented through the vent without any liquid water discharged from the tunnel oven.

4. The tunnel oven of claim 3 wherein:
the heater comprises a convection heater for indirectly heating the atmosphere in the passage so that the carbonaceous material is surrounded by heated atmosphere and thereby heated on all exposed surfaces and a radiant heater for radiantly heating the carbonaceous material transported through the passage; and
the heating temperature controller comprises an adjustable thermostat for measuring the temperature in the passage, the thermostat operably coupled to the heater for increasing or decreasing the amount of heating to provide an adjusted heating temperature.

5. The tunnel oven of claim 3 further comprising a cooling controller including an adjustable thermostat for measuring the cooled temperature in the second passage, the thermostat operably coupled to the water cooling mechanism for increasing or decreasing the amount of the quantity of water to provide an adjusted cooled temperature in the second length of passage.

6. The tunnel oven of claim 3 further comprising a plurality of heaters and wherein the heating temperature controller comprises a plurality of adjustable thermostats and sensors for measuring the heating temperature at a plurality of positions along the first length of the passage, the thermostats operably coupled to the heaters for increasing or decreasing the amount of heating and the another adjustable thermostat in the second length of the passage operably coupled to the water cooling mechanism for increasing or decreasing the amount of the quantity of water to provide an adjusted cooled temperature in the second length of the passage.

7. A tunnel oven for heating transported carbonaceous material in an oxidation free atmosphere and for discharging the heated material at a temperature below the oxidation temperature in air, the tunnel oven comprising:
an enclosure having a passage with an entrance for receiving solid carbonaceous material and an exit for discharging carbonaceous material;
a transport device for moving solid carbonaceous material through and along the passage and for discharging the carbonaceous material from the exit;
a heater operably connected to the enclosure to heat the carbonaceous material to a temperature above the oxidation temperature of the carbonaceous material as the carbonaceous material is moved along a first length of the passage;
a temperature controller operably coupled to the heater to provide one or more selected temperatures along the length of the passage; and
an atmosphere controller to control the atmosphere to exclude oxygen from along the passage; and
at least one cooler connected along a second length of the passage adjacent to the exit and a cooling controller for measuring the temperature in the second length of the passage, the thermostats operably coupled to the at least one cooler for increasing or decreasing the amount of cooling to provide an adjusted cooled temperature at the second length of the passage adjacent to the exit.

8. The tunnel oven for heating transported carbonaceous material of claim 7, wherein the cooler comprises at least one water spray mechanism placed in at least one position along the passage adjacent to a discharge at which the temperature of the carbonaceous material is cooled to below the oxidation temperature of the carbonaceous material such that the surface of the carbonaceous material is protected from oxidation combustion in the at least one position cooled by the water spray

9. A method for heating carbonaceous material to above its oxidation temperature and for discharging the carbonaceous material without oxidation, the method comprising:
transporting the carbonaceous material through an enclosure having a passage;
controlling the atmosphere along the passage to provide a non-oxidizing atmosphere;
heating the carbonaceous material transported through and along a first length of the passage to a temperature above the combustion temperature of the carbonaceous material in air;
cooling the carbonaceous material with water in a second length of the passage to a temperature above the boiling point of water and below the combustion temperature so that all the water is vaporized; and
venting the steam at the cooled temperature;
recovering a portion of the energy of the steam; and
discharging the cooled carbonaceous material without discharging any liquid water.

10. The method of heating carbonaceous material of claim 9, comprising:
venting the steam together with exhaust gases from the heated carbonaceous material;
recovering energy from the steam and the exhaust gases mixture at a mixture temperature above the cooled temperature and below the temperature of the exhaust gases in the first length of the passage;
an atmosphere controller to control the atmosphere along the length of the passage; and
wherein the atmosphere controller comprises a carbon dust injection mechanism by which carbon dust is injected into the passage at a position along the length, the carbon dust having a minimum dimension substantially less than the minimum dimension of the carbonaceous material transported through the tunnel oven such that any oxygen available for oxidation will combine with the carbon dust with much higher probability than the oxygen will combine with the solid carbonaceous material transported through the tunnel oven thereby protecting the surface of the carbonaceous material from oxidation.
